(19) United States
(12) Patent Application Publication
(10) Pub. No.: US 2026/0305606 A1
(43) Pub. Date: Oct. 8, 2026

(54) SEED COATING BINDER

(71) Applicant: CRODA INTERNATIONAL PLC, Goole, East Yorkshire (GB)

(72) Inventors: James Alexander FLAVELL, Goole, East Yorkshire (GB); Katharine Victoria NORMAN, Goole, East Yorkshire (GB)

(73) Assignee: CRODA INTERNATIONAL PLC, Goole, East Yorkshire (GB)

(21) Appl. No.: 19/482,448

(22) PCT Filed: May 8, 2024
(86) PCT No.: PCT/EP2024/062709

§ 371 Date: Nov. 7, 2025

(30) Foreign Application Priority Data
May 10, 2023 (GB) 2306899.2

(51) Int. Cl. A01N 25/24; A01N 25/10; A01P 21/00; C09D 167/08

(52) U.S. Cl. CPC A01N 25/24; A01N 25/10; A01P 21/00; C09D 167/08

(57) ABSTRACT

The present invention relates to binder for film and seed coating compositions. Said binder being an alkyd resin selected from those formed from C2 to C16 diacids, C6 to C30 fatty acids, and C3 to C8 polyols. The film or seed coating composition may also comprise agrochemical active, nutrient, or biostimulants. There is also provided a method of forming the film coating composition by combining said alkyd resin in a water medium, optionally with agrochemical active, nutrient, or biostimulants; a method of coating seeds, and seeds coated with said formulation. The alkyd resin comprising seed or film coating composition provides for desired binder properties and is water dispersible, whilst still maintaining good dust off and abrasion resistance, and having biobased and biodegradable properties. Said seed coating additionally does not suppress or hinder release of agrochemical active, nutrient, or biostimulant.

### CROSS REFERENCE TO RELATED APPLICATIONS

This application is the U.S. National Phase of PCT International Application No. PCT/EP2024/062709, filed May 8, 2024, which claims priority to Great Britain Patent Application No. 2306899.2, filed May 10, 2023, the contents of these applications being incorporated by reference herein in their entireties for all purposes.

### FIELD OF THE INVENTION

The present invention relates to binder for a film and seed coating composition, to a method of forming a film and seed coating composition comprising said binder and coating on to a seed, and to a seed coated with said composition.

### BACKGROUND OF THE INVENTION

Commercial agricultural practices have come to use coating compositions increasingly over the last few years. Typically these coating compositions are used to bind various components, such as agrochemical actives, to the surface of a plant or seed.

The purpose of the coating compositions may include a number of functions including adhering an agrochemical active to the seed or plant surface, adhering a pigment to a seed or plant surface, or simply for adding volume or bulk to a seed. In all cases the coating is desirably easy to apply, remains fixed to the seed or plant surface, may be permeable to water and/or air, resistant to dust off, and forms uniform coatings.

The present invention seeks to provide a binder suitable for use in coating compositions and formulations, where said binder is able to overcome the above described problems. Additionally, the present invention seeks to provide coatings which have desired properties of adhesion, dust off, germination, permeability, water retention etc. when applied to the seed surface. There is also a desire for said binders to be biobased and biodegradable.

The present invention also provides for the use of the coating composition in agrochemical coating compositions. The present invention also seeks to provide the use of dilute coating composition for treatment of seeds.

### SUMMARY OF THE INVENTION

According to a first aspect of the present invention there is provided a film coating composition comprising
i) a binder selected from an alkyd resin formed from C2 to C16 diacids, C6 to C30 fatty acids, and C3 to C8 polyols; and
ii) optionally, at least one selected from an agrochemical active, nutrient, or biostimulant.

According to a second aspect of the present invention there is provided a method of forming a film coating composition which comprises combining
i) a binder selected from an alkyd resin formed from C2 to C16 diacids, C6 to C30 fatty acids, and C3 to C8 polyols; and
ii) optionally, at least one selected from an agrochemical active, nutrient, or biostimulant dispersed in a water medium.

According to a third aspect of the present invention there is provided a method of coating seeds which comprises applying a seed coating composition which comprises a film coating composition in accordance with the first aspect, to said seeds.

According to a fourth aspect of the present invention, there is provided seeds with a seed coating, said seed coating composition comprising a film coating composition in accordance with the first aspect.

According to a fifth aspect of the present invention, there is provided the use of an alkyd resin formed from C2 to C16 diacids, C6 to C30 fatty acids, and C3 to C8 polyols, as a binder for a film coating composition for seeds.

According to a sixth aspect of the present invention there is provided an emulsified formulation comprising a binder selected from an alkyd resin formed from C2 to C16 diacids, C6 to C30 fatty acids, and C3 to C8 polyols, suitable for aqueous seed application.

### DETAILED DESCRIPTION OF THE INVENTION

It has been found that the binder of the present invention provides desired binder properties and is water dispersible. The binder maintains other good properties such as dust off, abrasion resistance and so forth, whilst also having desired biobased and biodegradable properties. Additionally, it has been found that the seed coating of the present invention does not suppress or hinder release of an agrochemical active, nutrient, or biostimulant comprised in said coating, or negatively impact seed germination.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.

The term ‘seed’ as used in this application is meant to refer in particular to the ripened ovule of gymnosperms and angiosperms, which contain an embryo surrounded by a protective cover. The protective cover can comprise the seed coat (testa). Some seeds comprise a pericarp or fruit coat around the seed coat. In particular, when this layer is closely adhered to the seed, as in cereal kernels, it is in some cases referred to as a caryopsis or an achene. As used in this application, the term ‘seed coat’ is meant to include a caryopsis or an achene. The term ‘seed’ includes anything that can be planted in agriculture to produce plants, including pelleted seeds, true seeds, plant seedlings, rootstock, regenerable and plant forming tissue, and tubers or bulbs.

The term ‘coating’ as used in this application, is meant to refer to applying material to a surface of a seed, for instance as a layer of a material around a seed. Coating includes film coating, pelleting, and encrusting or a combination of these techniques as known in the art. It will be understood that the term ‘film coating’ refers to a concentrated composition which can be diluted and formed into a slurry with other components added, such as agrochemical actives, in order to make a ‘seed coating’ which is then applied to the seeds or bulbs. The term ‘seed coating composition’ as used in this application is meant to refer to a composition to be used for coating of seed.

The coating is preferably applied over substantially the entire surface of the seed, such as over 90% or more of the surface area of the seed, to form a layer. However, the coating may be complete or partial, for instance over 20% or more of the surface area of the seed, or 50% or more.

It will be understood that, when describing the number of carbon atoms in a substituent group (e.g. ‘C1 to C6 alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branched groups.

The seed is a plant seed, for example a seed of an agricultural or field crop, a vegetable seed, an herb seed, a wildflower seed, an ornamental seed, a grass seed, a tree seed, or a bush seed.

Preferably, the plant seed is of an agricultural crop. The seed may be of the order of Monocotyledoneae or of the order of Dicotyledoneae. Suitable seeds include field crop seeds like soybean, cotton, maize, cereals including but not limited to wheat, barley, oat and rye, oil seed rape (or canola) sunflower, sugar beet, flax, rapeseed, tobacco, hemp seed, alfalfa, signal grass, sorghum, chickpea, beans, peas, rice, and sugar cane. Examples of suitable vegetable seeds include asparagus, chives, celery, leek, garlic, beetroot, spinach, beet, turnip, endive, chicory, parsley, fennel, radish, black salsify, eggplant, carrot, onion, tomato, pepper, lettuce, snap bean, shallot, safflower, chicory, and crops from the Brassicaceae or Cucurbitaceae families

Preferably, the plant seed is selected from field crop seeds. More preferably, selected from the group comprising of corn, soybean, cotton, and wheat. Most preferably, com.

Preferably, the plant seed is capable of germinating. Optionally, the seed may be deprived of husk (so called husked seed or de hulled seed).

The film and seed coating formulations of the present invention comprise binder, said binder being an alkyd resin.

Alkyd resins are polyesters that contain in their structure the functionality of saturated or unsaturated vegetable oils. They are made by esterifying triglycerides (or fatty acids) and various monofunctional and difunctional acids or anhydrides with a variety of di-, tri- and tetra-functional polyols.

Thus, in its simplest form, an alkyd resin may be obtained by reaction of a triglyceride drying oil as defined above with glycerol to give a trans esterified intermediate, which is further reacted with a polyfunctional acid to give the alkyd polymer, the chain length of which is determined by the ratio of mono to diglycerides in the mixture or the presence of other monofunctional species such as benzoic acid.

The polyfunctional acid typically used in this reaction is phthalic anhydride and its isomers, but other acids and combinations can also be used. Alkyds can be tailored to meet many end use requirements, either by changing reactants or reactant ratios, or by including modifiers.

Thus, the alkyd resin may be considered a reaction product of polyol, diacid, and fatty acid. The alkyd resin polymers of the present invention are formed from the reaction of C2 to C16 diacids, C6 to C30 fatty acids, and C3 to C8 polyols.

The term polyol is well known in the art, and refers to an alcohol comprising more than one hydroxyl group.

The polyol may be selected from triols, tetrols, pentols, hexols, heptols, or octols. Preferably, the polyol may be selected from triols, tetrols, pentols, hexols, or heptols. More preferably, the polyol may be selected from triols, tetrols, or hexols.

Suitable polyols may be selected from glycerol, diglycerol, triglycerol, tetraglycerol, erythritol, dierythritol, trierythritol, tetraerythritol, propylene glycol, 1,3-propanediol, trimethylolpropane, trimethylolethane, or pentaerythritol. Preferably, said polyol is selected from glycerol, diglycerol, triglycerol, tetraglycerol, trimethylolpropane, trimethylolpropane, isosorbide, or pentaerythritol. More preferably, said polyol is selected from glycerol, diglycerol, triglycerol, dimethylolpropane, trimethylolpropane, or pentaerythritol. Most preferably, glycerol, diglycerol, trimethylolpropane, or pentaerythritol.

In an alternative embodiment, sugar alcohols may be used to form the polyol, although it would be understood than non-sugar alcohols as noted above are preferred. In this specification the terms ‘sugars’ and ‘sugar alcohols’ refer to a group of saccharide derived polyols having from 4 to 7 hydroxyl groups. Examples of preferred sugars and sugar alcohols may include monosaccharides and disaccharides having from 4 to 7 hydroxyl groups.

Preferred sugar alcohols may be selected from glucose, fructose, sorbitol, sorbitan, xylitol, threitol, ribitol, fucitol, mannitol, sucrose, galactitol, iditol, inositol, or volemitol. Monosaccharide sugar alcohols may be particularly preferred. Further preferably, said sugar alcohols may be selected from glucose, fructose or sorbitol. Particularly sorbitol or sorbitan, may be preferred as polyols obtained from natural sources.

The diacid of the binder will be understood to be a molecule containing two carboxylic acid functional groups.

The diacid is selected from a C2 to C16 diacid. Preferably, a C4 to C12 diacid. More preferably, a C4 to C10 diacid.

The diacid may be of any suitable type including both linear, branched, cyclic diacids. In particular, a linear or cyclic diacid may be preferred. A particularly preferred type of diacid is a linear C2 to C16 diacid, more preferably a linear C4 to C10 diacid.

Suitable linear diacids may be selected from oxalic acid, malonic acid, succinic acid, glutaric acid, adipic acid, pimelic acid, suberic acid, azelaic acid, sebacic acid, undecanedioic acid, dodecanedioic acid, brassylic acid, and thapsic acid. Preferably, the diacid may be selected from succinic acid, glutaric acid, adipic acid, pimelic acid, suberic acid, azelaic acid, sebacic acid, and undecanedioic acid. More preferably, selected from succinic acid, adipic acid, azelaic acid, and sebacic acid. Most preferably, sebacic acid.

In an embodiment where cyclic diacids are preferred, suitable diacids may be a dehydrated diacid which results in an anhydride, said anhydride may be substituted or unsubstituted. Suitable anhydrides may be selected from succinic anhydride, and phthalic anhydride.

The fatty acids used in the present invention are C6 to C30 fatty acids. Preferably, selected from C8 to C30 fatty acids, more preferably C12 to C24 fatty acids, particularly C14 to C22 fatty acids, further preferably C16 to C22 fatty acids. Especially, C18 fatty acids may be preferred.

The fatty acids may be selected from linear or branched fatty acids. The fatty acids may be selected from saturated or unsaturated fatty acids.

Where unsaturated fatty acids are present, these may be selected from unsaturated fatty acids comprising at least one unsaturated carbon-carbon double bond. Particularly preferred are unsaturated fatty acids having in the range from 1 to 3 carbon-carbon double bonds. Most preferred are mono-unsaturated or di-unsaturated fatty acids residues. The carbon-carbon double bond(s) of the fatty chain may be present either in a cis or a trans configuration.

Preferably, the fatty acids residues used are derived from linear mono-unsaturated or di-unsaturated fatty acids. The preferred fatty acids may also comprise some tri-unsaturated fatty acids as it has been found that addition may improve cold liquid stability properties.

Iodine values are understood to represent the average amount of unsaturation of fats or oils, and is expressed in terms of the number of centigrams of iodine absorbed per gram of sample (% iodine absorbed). Where unsaturated fatty acids are present, said fatty acids may be selected such that the iodine value is greater than 70. Preferably, said iodine value is greater than 90. More preferably, said iodine value is greater than 100. Most preferably, said iodine value is greater than 110.

Suitable saturated fatty acids may be selected from caprylic acid, capric acid, lauric acid, myristic acid, palmitic acid, stearic acid, isostearic acid, arachidic acid, behenic acid, or lignoceric acid. Preferred saturated fatty acids may be selected from caprylic acid, capric acid, stearic acid, isostearic acid, or lauric acid.

Suitable unsaturated fatty acids may be selected from myristoleic acid, palmitoleic acid, sapienic acid, oleic acid, elaidic acid, vaccenic acid, linoleic acid, linoelaidic acid, arachidonic acid, eicosapentaenoic acid, erucic acid, or docosahexaenoic acid. Preferred unsaturated fatty acids may be selected from oleic acid, linoleic acid, linolenic acid, palmitoleic acid, or elaidic acid. Particularly preferred unsaturated fatty acids may be oleic acid, linoleic acid, and mixtures thereof.

In particular, most preferred fatty acids may be selected from isostearic (saturated, branched C18), stearic (saturated linear C18), isostearic (saturate branched C18), caprylic (saturated linear C8), lauric (saturated linear C12), and mixtures thereof.

The fatty acids may be unsaturated fatty acid mixtures obtained from natural fats and oils, e.g. canola oil, sunflower oil, soybean oil, olive oil, cotton seed oil, grape seed oil, peanut oil, rapeseed oil, safflower oil, cottonseed oil, or tall oil. Preferably canola oil, rapeseed oil, safflower oil, soybean oil, or tall oil. More preferably, soybean oil or rapeseed oil.

Particularly preferred fatty acids may be selected from soybean oil, stearic acid, or isostearic acid.

In an alternative embodiment, the fatty acid used may be purified prior to use in the present invention. Purification may be undertaken to raise the levels of desired fatty acid chains and reduce the level of undesired fatty acid chains in order to modify the iodine values, titre values, or pour points.

The fatty acid can be a mixture which is either formed by blending a number of different fatty acids, or a mixture that naturally occurs as a result of using a natural oil.

Specific alkyd resins formed from combinations of polyols, diacids, and fatty acids may be preferred. The preferred combinations may be selected from: glycerol-azelaic acid-rapeseed oil, glycerol-isostearic acid-adipic acid, glycerol-succinic acid-soybean oil, pentaerythritol-azelaic acid-soybean oil, trimethylolpropane-adipic acid-soybean oil, glycerol-adipic acid-isostearic acid, glycerol-azelaic acid-stearic/isostearic acid blend, diglycerol-azelaic acid-stearic/isostearic acid blend, diglycerol-sebacic acid-soybean oil, pentaerythritol-sebacic acid-soybean oil, glycerol-adipic acid-lauric acid, pentaerythritol-succinic anhydride-soybean oil, glycerol-adipic acid-adipic acid-stearic acid, pentaerythritol-adipic acid-caprylic acid, and glycerol-azelaic acid-soybean oil and stearic acid blend.

The alkyd resin formed may be of any suitable type including both linear and branched copolymers. Where the copolymer is linear, it may be a block, alternating, or periodic copolymer. Where the copolymer is branched, it may be a graft or star copolymer. In particular, a branched copolymer may be preferred.

The molecular weight of the alkyd resin is typically from 2,000 to 280,000 Da, particularly from 2,500 to 250,000 Da, more particularly from 3,000 to 220,000 Da, and especially about 3,500 to 210,000 Da.

In a particular embodiment, the molecular weight may be in the range from 92,000 to 220,000 Da, particularly from 100,000 Da to 180,000 Da, more particularly from 115,000 to 165,000 Da, and especially about 125,000 to 150,000 Da.

The molecular weight will be determined by size exclusion chromatography such as size-exclusion GPC (SE-GPC) as described herein, specifically the TSKgel GMPWXL Protocol.

The amount of C3 to C8 polyols present in the alkyd resin is in the range from 5 to 45 wt. % as a percentage of the total copolymer weight. More preferably, in the range of 7 to 40 wt. %. Further preferably, in the range of 10 to 38 wt. %. Most preferably, in the range of 15 to 35 wt. %.

The amount of C2 to C16 diacid present in the alkyd resin is in the range from 2 to 60 wt. % as a percentage of the total copolymer weight. More preferably, in the range of 5 to 55 wt. %. Further preferably, in the range of 8 to 50 wt. %. Most preferably, in the range of 10 to 45 wt. %.

The amount of C6 to C30 fatty acids present in the alkyd resin is in the range from 20 to 85 wt. % as a percentage of the total copolymer weight, More preferably, in the range of 25 to 80 wt. %. Further preferably, in the range of 30 to 75 wt. %. Most preferably, in the range of 35 to 70 wt. %.

The molar ratio of the fatty acid to polyol to diacid may be in the range 1:0.35-0.60:0.60-0.95. Preferably, in the range from 1:0.40-0.57:0.70-0.95. More preferably, in the range from 1:0.45-0.53:0.75-0.94.

The alkyd resin may be used in an emulsified form or an emulsification system, that can be combined with a film or seed coating formulation.

Preferably the carbon-containing parts of the alkyd resin are at least 60% biobased on the basis of the total weight of the carbon-containing parts of the composition, more preferably at least 70%, particularly at least 80% biobased.

The level of biobased content of the compound may be determinable by the standardised analytical method ASTM D6866 using ¹⁴C radiocarbon dating. ASTM D6866 distinguishes carbon resulting from bio-based inputs from those derived from fossil-based inputs. Using this standard, a percentage of carbon from renewable sources can be calculated from the total carbon in the sample.

The alkyd resin may be biodegradable. Preferably, at least 25% of the alkyd resin degrades within a 28 day period in accordance with the OECD methods 301B and 301F. More preferably, at least 30%. Most preferably, at least 40%.

The alkyd resin may therefore have the advantage from prior compounds used for this function in being more biobased, more biodegradable, and therefore more sustainable.

The alkyd resin may be made by any known method, and well within the knowledge of the skilled person in the field.

For example, the alkyd resin may be formed using the fatty acid process in a diacid, a polyol, and a fatty acid are combined and heated together until the product has achieved a predetermined level of viscosity.

The film or seed coating compositions may comprise one or more biologically active ingredients (including plant enhancing agents, in particular plant protective products (also referred to as PPPs)). Suitable examples of active ingredients, in particular plant enhancing agents, are fungicidal agents, bactericidal agents, insecticidal agents, nematicidal agents, molluscicidal agents, biologicals, acaricides or miticides, pesticides, and biocides.

Further possible active ingredients include disinfectants, microorganisms, rodent killers, weed killers (herbicides), attracting agents, (bird) repellent agents, plant growth regulators (such as gibberellic acid, auxin or cytokinin), nutrients (such as potassium nitrate, magnesium sulphate, iron chelate), plant hormones, minerals, plant extracts, germination stimulants, pheromones, biological preparations, etc.

Suitable agrochemical actives for use in the formulations according to the invention are all agrochemically active compounds that may be solid or liquid at room temperature. It is envisaged that the adjuvant of the present invention would have broad applicability to all types of agrochemical actives.

Agrochemical actives refer to biocides which, in the context of the present invention, are plant protection agents, more particular chemical substances capable of killing different forms of living organisms used in fields such as medicine, agriculture, forestry, and mosquito control. Also counted under the group of biocides are so-called plant growth regulators.

Biocides for use in agrochemical formulations of the present invention are typically divided into two sub-groups:
pesticides, including fungicides, herbicides, insecticides, algicides, moluscicides, miticides and rodenticides, and
antimicrobials, including germicides, antibiotics, antibacterials, antivirals, antifungals, antiprotozoals and antiparasites.

In particular, biocides selected from insecticides, fungicides, or herbicides may be particularly preferred.

The term ‘pesticide’ will be understood to refer to any substance or mixture of substances intended for preventing, destroying, repelling, or mitigating any pest. A pesticide may be a chemical substance or biological agent (such as a virus or bacteria) used against pests including insects, plant pathogens, weeds, mollusks, birds, mammals, fish, nematodes (roundworms) and microbes that compete with humans for food, destroy property, spread disease or are a nuisance. In the following examples, pesticides suitable for the agrochemical compositions according to the present invention are given.

A fungicide is a chemical control of fungi. Fungicides are chemical compounds used to prevent the spread of fungi in gardens and crops. Fungicides are also used to fight fungal infections. Fungicides can either be contact or systemic. A contact fungicide kills fungi when it comes into contact with the fungicide retained on leaf surfaces. A systemic fungicide is absorbed into plant tissues and kills the fungus when it attempts to invade the host.

Examples for suitable fungicides, according to the present invention, encompass the following (3-ethoxypropyl) mercury bromide, 2-methoxyethylmercury chloride, 2-phenylphenol, 8-hydroxyquinoline sulphate, 8-phenylmercuri oxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulphide, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, blasticidin-S, Bordeaux mixture, boscalid, bridged diphenyl fungicides, bromuconazole, bupirimate, Burgundy mixture, buthiobate, butylamine, calcium polysulphide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper (II) acetate, copper (II) carbonate, basic, copper fungicides, copper hydroxide, copper naphthenate, copper oleate, copper oxychloride, copper (II) sulphate, copper sulphate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, dinitrophenol fungicides, dinobuton, dinocap, dinocton, dinopenton, dinosulphon, dinoterbon, diphenylamine, dipyrithione, disulphiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulph, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, fluopicolide, fluoroimide, fluotrimazole, fluoxastrobin, fluquinconazole, flusilazole, flusulphamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, lime sulphur, mancopper, mancozeb, maneb, mebenil, mecarbinzid, mepanipyrim, mepronil, mercuric chloride, mercuric oxide, mercurous chloride, mercury fungicides, metalaxyl, metalaxyl-M, metam, metazoxolon, metconazole, methasulphocarb, methfuroxam, methyl bromide, methyl isothiocyanate, methylmercury benzoate, methylmercury dicyandiamide, methylmercury pentachlorophenoxide, metiram, metominostrobin, metrafenone, metsulphovax, milneb, morpholine fungicides, myclobutanil, myclozolin, N-(ethylmercury)-p-toluenesulphonanilide, nabam, natamycin, nitrostyrene, nitrothal-isopropyl, nuarimol, OCH, octhilinone, ofurace, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulphamide fungicides, phosdiphen, phthalide, phthalimide fungicides, picoxystrobin, piperalin, polycarbamate, polymeric dithiocarbamate fungicides, polyoxins, polyoxorim, polysulphide fungicides, potassium azide, potassium polysulphide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfiir, pyrrole fungicides, quinacetol, quinazamid, quinconazole, quinoline fungicides, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulphide, spiroxamine, streptomycin, strobilurin fungicides, sulphonanilide fungicides, sulphur, sultropen, TCMTB, tebuconazole, tecloftalam, tecnazene, tecoram, tetraconazole, thiabendazole, thiadifluor, thiazole fungicides, thicyofen, thifluzamide, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, trifloxystrobin, triflumizole, triforine, triticonazole, unclassified fungicides, undecylenic acid, uniconazole, urea fungicides, validamycin, valinamide fungicides, vinclozolin, zarilamid, zinc naphthenate, zineb, ziram, zoxamide, and mixtures thereof.

A herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Examples of herbicides that can be employed in the present disclosure include, but are not limited to: 4-CPA, 4-CPB, 4-CPP, 2,4-D, 3,4-DA, 2,4-DB, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofiuor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chiorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, diallate, dicamba, dichlobenil, dichloralurea, dichloiTnate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, flurtamone, fluthiacet, fomesafen, foramsulfuron, fosamine, furyloxyfen, glufosinate, glufosinate-P, glyphosate, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indazifiam, iodobonil, iodomethane, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxaflutole, isoxachlortole, isoxapyrifop, karbutilate, ketospiradox, lactofen, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, orthodichlorobenzene, orthosulfamuron, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thidiazimin, thiazafluoron, thiazopyr, thidiazuron, thiencarbazone-methyl, thifensulfuron, thiobencarb, tiocarbazil, tioclorim, topramezone, tralkoxydim, triallate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac tritosulfuron, vemolate, xylachlor and mixtures thereof. Safeners mean active ingredients applied with herbicides to protect crops against their injury. Some of the safeners that can be employed in the present disclosure include, but are not limited to: benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148, N-phenylsulfonylbenzoic acid amides and mixtures thereof.

Suitable herbicides may be selected from the group comprising: aryloxycarboxylic acid e.g. MCPA, aryloxyphenoxypropionates e.g. clodinafop, cyclohexanedione oximes e.g. sethoxydim, hydroxybenzonitriles e.g. bromoxynil, sulphonylureas e.g. nicosulphuron, triazolopyrimidines e.g. penoxsulam, triketiones e.g. mesotriones, triazine herbicides such as metribuzin, hexaxinone, or atrazine; sulphonylurea herbicides such as chlorsulfuron; uracils, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; isoxazolidone herbicides, phenoxyacetic acids; diphenyl ether herbicides such as fluazifop, acifluorfen, bifenox, or oxyfluorfen; dinitro aniline herbicides such as trifluralin; organophosphonate herbicides such as glufosinate salts and esters and glyphosate salts and esters; and/or dihalobenzonitrile herbicides such as bromoxynil, or ioxynil, benzoic acid herbicides, dipyridilium herbicides such as paraquat; and other herbicides such as clomazone, carfentrazone, saflufenacil, and pyroxasulphone.

An insecticide is a pesticide used against insects in all developmental forms, and include ovicides and larvicides used against the eggs and larvae of insects. Insecticides are used in agriculture, medicine, industry, and the household.

Examples of insecticides that can be employed in the present disclosure include, but are not limited to: 1,2-dichloropropane, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-ecdysone, alpha-endosulfan, amidithion, aminocarb, amiton, amiton oxalate, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bistrifluoron, borax, boric acid, bromfenvinfos, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chiOmafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin, ecdysterone, emamectin, emamectin benzoate, EMPC, empenfhrin, endosulfan, endothion, endrin, EPN, epofenonane, eprinomectin, esdepallethrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formetanate hydrochloride, formothion, fomiparanate, fomiparanate hydrochloride, fosmethilan, fospirate, fosthietan, fufenozide, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isofenphosmethyl, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, meperfluthrin, mephosfolan, mercurous chloride, mesulfenfos, metaflumizone, methacrifos, methamidophos, methidathion, methiocarb, methocrotophos, methomyl, methothrin, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, monocrotophos, monomehypo, monosultap, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluralin, profluthrin, promacyl, promecarb, propaphos, propetamphos, propoxur, prothidathion, prothiofos, prothoate, protrifenbute, pymetrozine, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spiromesifen, spirotetramat, sulcofuron, sulcofuron-sodium, sulfluramid, sulfotep, sulfoxaflor, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypei-methiin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos and mixtures thereof.

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such slugs and snails. These substances include metaldehyde, methiocarb and aluminium sulphate. A nematicide is a type of chemical pesticide used to kill parasitic nematodes (a phylum of worm).

Biologicals, which will be understood as products derived from living organisms such as bacteria or fungi, may also be used. Examples of suitable biologicals include bacilli, Trichoderma, rhizobia (for nitrogen fixation) and the like, which have been identified as seed treatment materials to protect plants and/or enhance their health and/or productive capacity.

Most preferably, the active if present in the film or seed coating formulation of the present invention is selected from an insecticide, and/or a fungicide. Preferably the insecticide, and/or a fungicide is a systemic insecticide, and/or a fungicide.

Most preferably, the active present in the film or seed coating formulation of the present invention may be selected from mefenoxam, fludioxonil, or imidacloprid. These lists are not exhaustive, new active ingredients are continuously developed and can be incorporated in the film and/or seed coating composition.

The formulation may comprise at least one nutrient. Nutrients refer to chemical elements and compounds which are desired or necessary to promote or improve plant growth. Nutrients generally are described as macronutrients or micronutrients. Suitable nutrients for use in the film or seed coating compositions according to the invention are micronutrient compounds, preferably those which are solid at room temperature or are partially soluble.

Nutrients may be present in addition to, or as an alternative to, agrochemical actives. In such formulations/compositions the nutrient is typically in a dry form.

The nutrients may preferably be a solid phase nutrients. Solid nutrients are to be understood in the present invention as meaning substances whose melting point is above 20° C. (at standard pressure). Solid nutrients will also include insoluble nutrient ingredients, i.e. nutrient ingredients whose solubility in water is such that a significant solid content exists in the film or seed coating composition after addition.

Micronutrients typically refer to trace metals or trace elements, and are often applied in lower doses. Suitable micronutrients include trace elements selected from zinc, boron, chlorine, copper, iron, molybdenum, and manganese. It is envisaged that the binder of the present invention would have broad applicability to all types of micronutrients.

The micronutrients may be in a soluble form or included as insoluble solids, and may be in the form of salts or chelates. Preferably, the micronutrient is in the form of a carbonate or oxide.

Preferably, the micronutrient may be selected from zinc, calcium, molybdenum or manganese, or magnesium. Particularly preferred micronutrients for use with the present invention may be selected from zinc oxide, manganese carbonate, manganese oxide, or calcium carbonate.

The amount of micronutrient in the film or seed coating composition, if present, may typically be in the range from 5 wt. % to 40 wt. %, more usually, 10 wt. % to 35 wt. %, particularly 15 wt. % to 30 wt. %, by weight based on the total film or seed coating composition.

Typically, as mixed into formulations during make up the average particle size of solid agrochemicals is from 50 μm to 100 μm, but formulations are typically wet milled after mixing to reduce the average particle size to from 1 μm to 10 μm, more preferably from 1 μm to 5 μm.

The formulations of the present invention may also comprise at least one macronutrient. Macronutrients typically refer to those comprising nitrogen, phosphorus, and potassium, and include fertilisers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

Biostimulants may enhance metabolic or physiological processes such as respiration, photosynthesis, nucleic acid uptake, ion uptake, nutrient delivery, or a combination thereof. Non-limiting examples of biostimulants include seaweed extracts, humic acids (e.g., potassium humate), fulvic acids, myoinositol, glycine, jasmonic acid, benzoic acid, diphenyl urea, and combinations thereof.

Agrochemically active compounds, including insecticides and fungicides, require a formulation which allows the active compounds to be taken up by the coated seed.

The term ‘agrochemical formulation’ as used herein refers to either the film or seed coating compositions including an active agrochemical, nutrient, or biostimulant. It is intended to include all forms of compositions. The binder of the present invention may be combined with other components in order to form an agrochemical film coating formulation comprising at least one agrochemical active. The formulations of the present invention are water based suspension type formulations.

As noted herein, film coatings are concentrated composition which can be diluted and formed in to a slurry with other components added, such as agrochemical actives, in order to make a seed coating which is then applied to the seeds. Film coatings generally can be used for encapsulation of plant protectants on treated seeds that do not require increasing the weight or changing the shape of the seed prior to planting.

The binder is suitably present in the film coating composition at a concentration in the range from 2 wt. % to 40 wt. %, preferably 4 wt. % to 25 wt. %, more preferably 5 wt. % to 22 wt. % based on the total weight of the film coating composition.

A particular advantage of the present invention may be that the film and resulting seed coating composition may be free or substantially free of microplastic and/or microplastic particles as defined by relevant regulatory authorities.

The term ‘microplastic’ and ‘microplastic particles’ as used in this application is meant to refer in particular to material consisting of solid polymer-containing particles, to which additives or other substances may have been added, and where more than 1% w/w of particles have dimensions between 1 nm and 5 mm, or for fibres a length of 3 nm to 15 mm and length to diameter ratio of greater than 3. Said polymers would not include those which are naturally occurring and not chemically modified (other than by hydrolysis), and not include polymers that are biodegradable.

Preferably the film and resulting seed coating composition comprises less than 5 wt. % of microplastics and/or microplastic particles, more preferably less than 3 wt. %, further preferably less than 2 wt. %, even further preferably less than 1 wt. %, and particularly less than 0.5 wt. % based on the total weight of the composition. In a particularly preferred embodiment the film and resulting seed coating composition may be free of any microplastic particles.

The film coating composition and/or the seed coating composition may also include other components as desired. These other components may be selected from those including:
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, e.g. polysiloxane antifoam agents, typically in amounts of 0.005 wt. % to 10 wt. % of the formulation;
viscosity modifiers such as commercially available water soluble or miscible gums, e.g. xanthan gums, and/or cellulosics, e.g. carboxy-methyl, ethyl or propylcellulose;
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation; and/or & pigment concentrates, effect and pearlescent pigments.

The amount of water in the seed coating composition is suitably less than 85%, preferably less than 80%, more preferably less than 75%, particularly in the range from 35 to 70%, and especially 45 to 65% by weight based on the total weight of the composition.

The seed coating composition of the invention may also comprise a surface active agent such as a wetting, dispersing and/or emulsifying agent. The surface active agent may aid in mixing/emulsifying/dispersing the wax and/or pigment particles in the pre-blend and seed coating composition.

The seed coating composition of the invention may comprise further components such as one or more selected from a solvent, a thickener, an anti-foaming agent, a preservative, and a slip additive.

Suitable thickeners include agar, carboxy methylcellulose, carrageenan, chitin, fucoidan, ghatti, gum arabic, karaya, laminaran, locust bean gum, pectin, alginate, guar gum, xanthan gum, diutan gum, and tragacanth, bentonite clays, HEUR (hydrophobically modified, ethoxylated urethane) thickeners, HASE (hydrophobically modified, alkali-swellable emulsion) thickeners and polyacrylates. Gums are generally preferred because of their low cost, availability and superior ability to enhance the physical characteristics of the resultant coated film.

Examples of suitable antifoaming agents include polyethylene glycol, glycerine, mineral oil defoamers, silicone defoamers, and non-silicone defoamers (such as polyethers, polyacrylates), dimethylpolysiloxanes (silicone oils), arylalkyl modified polysiloxanes, polyether siloxane copolymer containing fumed silica. The antifoaming agent may be present in some embodiments of the seed coating composition in an amount of at least 1 ppm by weight, or 0.1 to 0.3% by weight based on the total weight of the seed coating composition.

The seed coating composition further may comprise one or more solvents other than water. Solvents may be selected from the group consisting of alcohols, and hydrocarbons. Also mixtures of solvents can be used. It is preferred that the solvent is liquid at 20° C. and 1 atm.

Examples of suitable solvents include glycols and their esters and ethers, in particular ethylene and propylene glycols and their esters and ethers, for instance, esters and ethers with C1-C6 alkyl groups and/or aromatic groups, such as methyl, ethyl, propyl, butyl, benzyl and phenyl ethers, including mono ethers and dialkyl ethers, and esters of these ethers, such as acetates, and ethylene and propylene glycol esters, for instance of fatty acids; polyethylene glycol (PEG) and polypropylene glycol and esters thereof, especially with fatty acids; butyl cellosolve, butyl carbitol, polyethylene glycol; N methylpyrrolidone, glycerine, alkyl alcohols with up to 10 carbon atoms, such as ethanol, propanol and butanol.

Other examples of solvents include dipropylene glycol methyl ether and propylene glycol methyl ether. An important solvent is ethylene glycol. Further examples include propylene tetramer and synthetic ester oils such as lactate esters, particularly ethyl lactate and benzoate esters e.g. iso-propyl or 2-ethylhexyl benzoates. Aromatic hydrocarbons such as xylene, aliphatic and paraffinic solvents and vegetable oils can also be used as solvent. Aromatic solvents are less preferred.

The seed coating composition may also comprise components with a plasticising effect, such as surfactants or antifreeze agents. Common surfactants include amphiphilic organic compounds, usually comprising a branched, linear or aromatic hydrocarbon, fluorocarbon or siloxane chain as tail and a hydrophilic group. Some types of surfactants include non-ionic, anionic, cationic and amphoteric surfactants, and organosilicone and organofluorine surfactants.

Some examples of surfactants include polyoxyethylene glycol and polyoxypropylene ethers and esters, in particular alkyl, aryl and alkylaryl ethers thereof, and sulphates, phosphates and sulphonic acid compounds of such ethers, glucoside (alkyl) ethers, glycerol esters, such as alkyl and fatty acid esters, sorbitan (alkyl) esters, acetylene compounds, cocamide compounds, block copolymers of polyethylene glycol and propylene glycol. Further examples of surfactants include alkylamine salts and alkyl quaternary ammonium salts, for example betaine type surfactants, amino acid type surfactants; and polyhedric alcohols, fatty acid esters, in particular C12-C18 fatty acids, for instance of polyglycerin, pentaerythritol, sorbitol, sorbitan, and sucrose, polyhydric alcohol alkyl ethers, fatty acid alkanol amides, and propoxylated and ethoxylated compounds such as fatty alcohol ethoxylates, polyethyxlated tallow amine and alkylphenol ethoxylates. Some examples of anionic surfactants include carboxylic acids, copolymers of carboxylic acids, sulphates, sulphonic acid compounds and phosphates, for example lignin sulphonates and (linear) alkylaryl sulphonates.

Anti-freeze agents include for example: ethylene glycol, propylene glycol, 1,3 butylene glycol, hexylene glycol, diethylene glycol, and glycerin, with the preferred glycol being ethylene glycol and propylene glycol.

The film and/or seed coating composition of the present invention may also contain one or more optional pigments, which function to provide an aesthetic effect when coated on seed. The pigment is preferably an inorganic material and may, for example, be an effect pigment and/or a coloured pigment as known in the art.

Examples of suitable effect pigments include pearlescent pigment in different particle sizes. Effect pigments having a particle size of 60 μm or less, or a particle size of 15 μm or less may be used. The particle size of the effect pigment is preferably not more than 200 μm, more preferably not more than 100 μm. Usually, the particle size of the effect pigment is 1 μm or more. Another effect pigment can be aluminium. Effect pigments can be used to create an attractive cosmetic look on the seeds.

Examples of coloured pigments include pigment red 112 (CAS No. 6535-46-2), pigment red 2 (CAS No. 6041-94-7), pigment red 48:2 (CAS No. 7023-61-2), pigment blue 15:3 (CAS No. 147-14-8), pigment green 36 (CAS No. 14302-13-7), pigment green 7 (CAS No. 1328-53-6), pigment yellow 74 (CAS No. 6358-31-2), pigment orange 5 (CAS No. 3468-63-1), pigment violet 23 (CAS No. 6358-30-1), pigment black 7 (CAS No. 97793 37 8), and pigment white 6 (CAS No. 98084-96-9). The particle size of the coloured pigment is preferably not more than 100 μm, more preferably not more than 50 μm. Usually, the particle size of the coloured pigment is 25 μm or more.

A dye such as anthraquinone, triphenylmethane, phthalocyanine, derivatives thereof, and diazonium salts, may be used in addition to or as an alternative to a coloured pigment.

The amount of pigment in the film and/or seed coating composition, if present, is suitably in the range from 0.1 to 15%, preferably 1.0 to 8.0%, more preferably 2.0 to 5.0%, particularly 2.5 to 3.5%, and especially 2.8 to 3.2% by weight based on the total weight of the composition.

A biocide can be included in some embodiments of the seed coating composition for instance as preservative, in order to prolong the shelf life of the seed coating composition before being applied to a seed, such as when being stored. Examples of suitable biocides include MIT (2 methyl 4-isothiazolin-3-one; CAS No. 2682 20-4), BIT (1,2 benzisothiazolin-3-one; CAS No. 2632-33-5)), CIT (5-Chloro-2-methyl-4-isothiazolin-3-one), Bronopol (2-Bromo-2-nitro-propane-1,3-diol) and/or a combination of these.

Coating includes coating techniques as known in the art. It is envisaged that the present invention applies to all said coatings types.

The film coating composition of the present invention can be diluted and formed in to a slurry with other components added in order to make the seed coating composition which is then applied to the seeds or bulbs.

The seed coating composition of the invention may be applied to the seed in conventional manners.

The seed may be primed or not primed (having been subjected to a treatment to improve the germination rate, e.g. osmopriming, hydropriming, matrix priming).

Preferably, the seed coating composition is applied as a liquid composition and/or emulsion and/or dispersion and/or latex composition and thereafter solidified (including cured and/or dried) to form a seed coating. The term ‘liquid coating composition’ as used in this application is meant to include coating compositions in the form of a suspension, emulsion, and/or dispersion, preferably a dispersion.

Conventional means of coating may be employed for coating the seeds. Various coating machines are available to the person skilled in the art. Some well known techniques include the use of drum coaters, fluidised bed techniques, rotary coaters (with and without integrated drying), and spouted beds. Suitably, the seed coating composition is applied to the seed by a rotary coater, a rotary dry coater, a pan coater or a continuous treater.

Typically, the amount of seed coating composition applied to the seed can be in the range of 0.1 to 200 g dry wt. per kg seed, preferably 0.15 to 150 g dry wt. per kg seed, more preferably 0.25 to 100 g dry wt. per kg seed.

The seed coating composition can, for instance, be applied by film coating, spraying, dipping, or brushing of the seed coating composition. Optionally, it is applied at a temperature of 25° C. to 50° C., for instance 5° C. to 35° C., more often 15° C. to 30° C., for instance at room temperature, such as 18° C. to 25° C. Preferably, the seed coating composition is applied to the seed by film coating. The film coating may suitably be applied by spraying the liquid coating composition onto the seed, typically while the seeds fall or flow through a coating apparatus. Preferably, the method comprises film coating of the seed to apply the seed coating composition in the form of a film coating composition.

Preferably, the method comprises applying the seed coating composition to form a film or seed coating layer.

The seed coating composition is suitably applied to the seed such that the ratio of the dried coating layer to seed is suitably in the range from 0.001 to 20:1, preferably 0.05 to 10:1, more preferably 0.01 to 1.0:1, particularly 0.05 to 0.5:1, and especially 0.1 to 0.2:1 by weight.

Seed coating typically involves forming on the surface of the seeds a firmly adhering, moisture permeable coating. The process typically comprises applying a liquid seed coating composition to the seeds before planting.

An additional film coat layer may optionally be applied over the top of the coating, layer of the invention to provide additional benefits, including but not limited to cosmetics, coverage, actives, nutrients, and processing improvements such as faster drying, seed flow, durability and the like.

The binder of the present invention when applied to a seed surface provides for a germination rate which is not negatively affected when compared to untreated seeds.

Coatings also provide good wet and dry flow to coated seeds. The result of this is the seeds can be bagged and sold to be used later or used straight away, and seeds are not wet as this would result in seeds stick together during storage. The binder of the present invention when applied to a seed surface provides for dry and wet flowability rates which is not negatively affected when compared to untreated seeds.

The coatings formed of the present invention also provide for a desired viscosity which allows for ease of handling and application to any seeds to be coated.

The coating provides good dust off and abrasion resistance thereby reducing dust produced during movement of the seeds and allowing lower amounts of active to be incorporated due to decreased coating loss.

The seed coating composition provides for coatings which are more uniform across a seed, and good film forming properties and no need for an added film-former. The coating is also found to be tough and flexible coating with good adhesion.

It will be appreciated particle size and distribution is a factor which reflects the stability of the dispersion/emulsion. It is important that there is a homogeneous distribution of the particles to ensure stability for a longer period. It is important that any components added do no lead to particles coming together or cause phase separation. Therefore, stable particle size, homogeneous particle distribution, and limited particle size growth over time, is likely to provide more stability.

In the form of a distribution of particle sizes, the particles would have a median volume particle diameter value. It will be understood that the median volume particle diameter refers to the equivalent spherical diameter corresponding to the point on the distribution which divides the population exactly into two equal halves. It is the point which corresponds to 50% of the volume of all the particles, read on the cumulative distribution curve relating volume percentage to the diameter of the particles i.e. 50% of the distribution is above this value and 50% is below. This value is referred to as the “D (v,0.5)” value and is determined as described herein. Additionally, “D (v,0.9)” values can also be referred to, and these values would be the equivalent spherical diameter corresponding to 90% of the volume of all the particles, read on the cumulative distribution curve relating volume percentage to the diameter of the particles, i.e. they are the points where 10% of the distribution is above this value and 90% are below the value respectively.

The particle size values, used to determine the D (v,0.9) values, are measured by techniques and methods as described in further detail herein.

It is generally known that particle sizes of 200-18,000 nm are preferred in order to obtain a stable dispersion/emulsion having the desired properties.

The particles present in the emulsion of the present invention may have a D (v,0.9) value in the range from 100 nm to 4,000 nm. Preferably, in the range from 150 nm to 3,500 nm. More preferably, in the range from 200 nm to 3,000 nm.

All of the features described herein may be combined with any of the above aspects, in any combination.

### EXAMPLES

In order that the present invention may be more readily understood, reference will now be made, by way of example, to the following description.

It will be understood that all tests and physical properties listed have been determined at atmospheric pressure and room temperature (i.e. 25° C.), unless otherwise stated herein, or unless otherwise stated in the referenced test methods and procedures.

The following test methods were used to determine performance of the adjuvant compositions.
Molecular weight—This was determined using the GPC method with chromatograph Agilent 1260 Infinity/1290 Infinity II, column PL gel 5 μm mixed D, and a refractive index detector. A 1% w/v sample was made up in tetrahydrofuran solvent, and used in an injection volume of 50 μL, with flow rate 1 cm³ min⁻¹ through the column which was at a temperature of 40° C. The analysis time was 30 minutes and area normalisation was used. A standard of polystyrene (Agilent EasiVial PS-M 2 ml GPC/SEC Calibration Standards; Mp range: 162 to 364,000 Da) was used.
Acid value—A 5 g sample of the alkyd resin was accurately weighed (to 0.1 mg) into a 250 cm³ flat-bottomed flask. 10 cm³ xylene and a quantity of anti-bumping granules were added and the flask heated until the xylene began to boil and the anti-bumping granules moved freely when the flask was swirled. A 50 cm³ portion of industrial denatured alcohol (IDA) was added and heated to brief reflux. 1 cm³ of 1% phenolphthalein in IDA was added and the acidity titrated with 0.5 M aqueous sodium hydroxide solution. The acid value was calculated as AV=56.105xt/w mg KOH g⁻¹, where x=molarity of NaOH, T=titre (cm³) and w=weight of alkyd resin (g).
Dust-off—This was measured by the industry standard, Heubach dust method provided by the European Seed Association. This is the accepted assessment of free floating dust and abrasion particles of treated seeds as a parameter of the quality of treated seeds. 200 grams of seeds were submitted to a five minute Heubach test type 1 in triplicate, averaging the results to a total amount of dust-off per 100 kilograms of seeds. A glass filter grade GF9 was weighed before and after testing to determine dust off amount.
Germination Testing—Germination testing was carried out in accordance with the following test method:
   Approx. 1 m of paper towel (4 squares) is folded and wet with 20 mL water. 50 coated seeds are spread over the wet towel. The paper towel containing the seeds is then rolled up. It is then placed in a jar with a further 20 ml of water, covered with a plastic bag and secured. The jars are placed in a growth cabinet for 5 nights, 6 days (temperature controlled at 25° C. and in darkness). The seeds are then classified and counted.
Upon completion of the above protocol the seeds were split into six categories for no germination, sprout visible, root and sprout visible, multiple roots and sprout visible, multiple roots and sprout large sprout, multiple roots and large sprout with first with first leaf clearly visible. The conditions are in line with the International Rules for Seed Testing (ISTA).
Percentage solids—An Ohaus MB120 moisture analyser was used to assess the percentage solids. Samples were dried to a constant weight, allowing calculation of the percentage solids.
Particle size values (PSD) D (v,0.9)—Particle size was analysed by dynamic light scattering using a Malvern Zetasizer using a particle refractive index of 1.56. Each sample was assessed and the average of 55 measurements recorded, with each measurement lasting 15 seconds.

The following materials were used in the examples:
Soy fatty acid—8-12% C16:0, <6% C18:0, 20-35% C18:1, 45-60% C18:2, 2-10% C18:3

With other polyols, fatty acids, and diacids as stated in the relevant tables.
Maxemul 7101—non-ionic surfactant-based O/W emulsifier and dispersant
Maxemul 7201—anionic oil soluble surfactant
Atlox 4913—acrylic copolymer surfactant
Atlas G-5002L—high HLB polyalkylene oxide block copolymer emulsifier
Silcolapse 5.001—silicone anti-foam
Proxel GXL—anti-bacterial, formaldehyde free glycol/alcohol solution

### Binder Formation

The following methods were used to synthesis a range of alkyd resins for seed coating evaluation,

### Method 1—Using Xylene as Water Removal Aid

A 5-necked flask equipped with a magnetic sealed stirrer guide with PTFE centrifugal stirrer, temperature feedback probe and isomantle, a nitrogen inlet and outlet via a Dean and Stark trap (pre-filled with xylene) with a Liebig condenser to an exit bubbler was charged with fatty acid, polyol and xylene (3 wt. %), and heated with stirring (350 rpm) under a flow of nitrogen (15 ml min 1) to 220° C. until the quantity of water collected in the Dean and Stark trap was equal to the theoretical quantity calculated for an acid value of 15 mg KOH g⁻¹.
The reaction mix was cooled to 170° C. and diacid added. The reaction was heated to 220° C. as before until the acid value had fallen to ca. 20 mg KOH g⁻¹. The reaction apparatus was re-configured for distillation and the xylene was removed. Vacuum was applied (<10 mbar) to continue the esterification reaction for an additional until an acid value of 10 (=2) mg KOH g 1 was achieved. After cooling to below 100° C. the alkyd resin was obtained as a viscous yellow oil.
Method 1 used when the diacid was 6 carbons or less, i.e. for polymers P2, P3, P4, P7, P8, and P9.

### Method 2—No Xylene

A 5-necked flask equipped with a magnetic sealed stirrer guide with PTFE centrifugal stirrer, temperature feedback probe and isomantle, a nitrogen inlet and outlet via a distillation arm with a Liebig condenser and receiver flask to an exit bubbler was charged with fatty acid, polyol and diacid.
The reaction mix was heated to 190° C. for 1 hour and the temperature was increased to 220° C. for a further 1 hour. The distillation arm was replaced with a simple pot-to-pot distillation tube and vacuum applied to 200 mbar and the reaction allow to continue until an acid value of 10-2 mg KOH g 1 was achieved. The alkyd resin was obtained as a viscous yellow oil.
Method 2 used when the diacid is greater than 6 carbons, i.e. for polymers P1, P5, and P6.

The following polymers in Table 1 were formed using the methods described herein.

TABLE 1
Alkyd resins formed

| Alkyd | Fatty | | |
|---|---|---|---|
| resin | acid | Polyol | Diacid |
| P1 | Soy | Glycerol | Sebacic acid |
| P2 | Isostearic | Glycerol | Adipic acid |
| P3 | Soy | Trimethylolpropane | Adipic acid |
| P4 | Soy | Pentaerythritol | Succinic anhydride |
| P5 | Soy | Glycerol | Azelaic acid |
| P6 | Stearic/ | Diglycerol | Sebacic acid |
| | Isostearic | | |
| P7 | Caprylic | Glycerol | Adipic acid |
| P8 | Soy | Glycerol | Adipic acid |
| P9 | Soy | Pentaerythritol | Adipic acid |
| P10 | Soy | Diglycerol | Sebacic acid |

The acid values and molecular weights of the synthesised alkyd resin polymers were then determined using the methods described herein, with results shown in Table 2.

TABLE 2
Acid values and molecular weights

| Alkyd resin polymer | Acid Value | MW of polymer |
|---|---|---|
| P1 | 10.9 | 48600 |
| P2 | 11.8 | 39,300 |
| P3 | 10.7 | 10,300 |
| P4 | 9.8 | 12,200 |
| P5 | 9.3 | 21,500 |
| P6 | 11.9 | 53,600 |
| P7 | 9.6 | 26,800 |
| P8 | 9.5 | 21,500 |
| P9 | 10.1 | 14,000 |
| P10 | 11.6 | 137.100 |

### Emulsions Formed

The alkyd resin polymers were then used to form a number of emulsion systems. The emulsion systems were formed using the following method:
A cylindrical (flat bottomed) glass vessel with a full surrounding jacket for a heating fluid, equipped with an Intermig impeller (EKATO) having a diameter only slightly less than the vessel was charged with the alkyd resin (200 g). The circulator fluid temperature was set to 75° C. and the stirring rate to 50 rpm.
A quantity of water calculated to give the required final weight for the emulsion was charged to a flat-bottomed flask and placed on a hotplate set to the emulsification temperature to pre-heat the water for emulsification.
Once the set temperature was reached a quantity of KOH calculated to neutralise 40% of the acid value of the alkyd resin was added to the emulsification vessel and the stirring rate increased to 100 rpm.
After 30 min, the emulsifiers were added to the vessel (3% each on alkyd weight) and the stirrer speed increased to 175 rpm. After an additional 30 min, the circulator fluid temperature was decreased to the emulsification temperature for the particular alkyd resin (determined by alkyd viscosity).
Addition of the water for emulsification was begun by peristaltic pump pre-calibrated to an addition rate of 0.4 cm³ min⁻¹; inversion of the emulsion phase from W/O to O/W occurred after approximately half of the total volume of water had been added, after which the water addition rate was increases incrementally to 1.6 cm³ min⁻¹ until addition was complete.

TABLE 3
Alkyd resin emulsion systems

| Alkyd | | | | PSD | Solids |
|---|---|---|---|---|---|
| resin | Emulsion | Emulsifier 1 | Emulsifier 2 | (nm) | (%) |
| P1 | E1 | Maxemul 7101 | Maxemul 7201 | 1212 | 51.7 |
| P2 | E2 | Maxemul 7101 | Maxemul 7201 | 1103 | 51.8 |
| P3 | E3 | Maxemul 7101 | Maxemul 7201 | 283.8 | 51.4 |
| P4 | E4 | Maxemul 7101 | Maxemul 7201 | 1173 | 51.0 |
| P5 | E5 | Maxemul 7101 | Maxemul 7201 | 1106 | 51.4 |
| P6 | E6 | Maxemul 7101 | Maxemul 7201 | 235.7 | 51.1 |
| P7 | E7 | Maxemul 7101 | Maxemul 7201 | 220.4 | 49.3 |
| P8 | E8 | Maxemul 7101 | Maxemul 7201 | 307.7 | 51.1 |
| P9 | E9 | Maxemul 7101 | Maxemul 7201 | 315.6 | 50.4 |
| P10 | E10 | Maxemul 7101 | Maxemul 7201 | 244.3 | 51.8 |

The results show in Table 3 for PSD and solid content demonstrate that a stable emulsion was formed.

### Seed Coating Formed

Important to the success of any seed coating is the film-former agent that will improve the adherence of components that includes active ingredient to the surface of the seed. The addition of the film-former agent requires a good deal of precision, identifying correct chemistry that will provide adherence under mechanical stress in order to avoid dust-off release and abrasion performance without compromising flowability and germination. The binder of the present invention was therefore assessed with regard to these properties.

Coating formulations were prepared using the following method. All ingredients except premix water, xanthan, Vangel B and imidacloprid were combined under stirring 500 rpm. Imidacloprid was added whilst under continuous stirring.

The slurry was then milled for 15 minutes 3,500 rpm using an Eigar Torrence mini motor mull. The remaining ingredients were added as a premix with stirring 500 rpm, and the formulation was stirred until homogeneous at 500 rpm.

A formulation was prepared with the following recipes as shown in Table 4.

TABLE 4
Imidacloprid based formulation

| Component | g/l | w/w % |
|---|---|---|
| Imidacloprid | 526.32 | 44.05 |
| Atlox 4913 | 50.0 | 4.18 |
| Atlas G-5002L | 10.0 | 0.84 |
| Binder agent | 108.0 | 9.04 |
| Monopropylene Glycol | 50.0 | 4.18 |
| Silcolapse 5.001 | 1.0 | 0.08 |
| Proxel GXL | 1.0 | 0.08 |
| Xanthan Gum | 3.0 | 0.25 |
| Dye slurry | 150.0 | 12.55 |
| Deionised water | 295.55 | 24.74 |

### Seed Treatment

The formulation formed were applied as a seed treatment after 24 hours at room temperature. The treatment was applied to corn seeds at a treatment rate of 0.6 g A.I. per kg of wheat seed.

The formulation was diluted to a slurry rate of 10.4 ml/kg (in accordance with Valent published patent application US2012/088806) and 1.03 ml of the FS and 9.37 ml of deionised water was used to form the slurry.

The seeds were treated, with 500 g of corn seeds treated with 1.04 ml per 100 g (5.2 ml in total) of slurry in a Winterseiger drum seed coater seed treater for 1 minute.

### Dust Off Results

Dust-off testing measures the amount of dust released from the seed. Treated seeds were put into a Heubach Dustmeter device which keeps the seeds gently circulating inside a small drum with an air stream passing through, and a fiberglass filter to trap dust particles.

The methodology measures seed treatment (active ingredient or other components) that flake off or result in dust. Overall, the seed treatment desirably should have a high resistance to abrasion with minimal dust loss.

TABLE 5
Treatment 1 Imidacloprid FS

| Coating system | Average dust off | % Improvement |
|---|---|---|
| PPP alone (control) | 0.58 | N/A |
| E1 | 0.07 | 88 |
| E2 | 0.23 | 59 |
| E3 | 0.08 | 86 |
| E4 | 0.26 | 55 |
| E5 | 0.25 | 56 |
| E6 | 0.20 | 66 |
| E7 | 0.17 | 69 |
| E8 | 0.30 | 47 |
| E9 | 0.24 | 57 |
| E10 | 0.07 | 88 |

Units shown are g/100 kg of seed.

Table 5 shows various alkyds with treatment 1 all treatments show an improvement over the control formulation

TABLE 6
Treatment 2 Mefenoxam + Fludioxonil FS

| Coating system | Average dust off | % Improvement |
|---|---|---|
| PPP alone (control) | 0.18 | N/A |
| E1 | <0.01 | 97 |
| E2 | 0.02 | 86 |
| E3 | 0.03 | 84 |
| E4 | <0.01 | 99 |
| E5 | 0.02 | 86 |
| E6 | 0.02 | 89 |
| E7 | 0.02 | 89 |
| E8 | 0.01 | 92 |
| E9 | 0.01 | 95 |

Units shown are g/100 kg of seed.

The Mefenoxam+Fludioxonil FS is a trade formulation available from Syngenta called Maxim XL. Table 6 shows various alkyds with treatment 2 all treatments show an improvement over the control formulation

TABLE 7
Treatment 3 Disco film coat

| Coating system | Average dust off | % Improvement |
|---|---|---|
| PPP alone (control) | 0.21 | N/A |
| E1 | 0.06 | 73 |
| E2 | 0.02 | 90 |
| E3 | 0.01 | 97 |
| E4 | 0.01 | 97 |
| E5 | <0.01 | 99 |
| E6 | 0.01 | 97 |
| E7 | <0.01 | 99 |
| E8 | <0.01 | 99 |
| E9 | 0.01 | 97 |

Units shown are g/100 kg of seed.

The Disco formulation is coded L-1101 and is a blend available from Incotec. Table 7 shows various alkyd resins with treatment 3. All treatments show an improvement over the control formulation

### Germination Results

The seed coatings were then tested for germination performance, and to ensure that the binder didn't cause any undesired negative effect for germination.

TABLE 8
Germination results

| | | | Stages | | | | | |
|---|---|---|---|---|---|---|---|---|
| Seed treatment | Seeds | Sprouted | 1 | 2 | 3 | 4 | 5 | 6 |
| Untreated corn | 50 | 47 | 2 | 2 | 8 | 19 | 14 | 2 |
| Treatment 1 PPP alone | 50 | 49 | 1 | 5 | 4 | 19 | 20 | 0 |
| Treatment 2 PPP alone | 50 | 48 | 2 | 3 | 6 | 18 | 15 | 4 |
| Treatment 1 E1 | 50 | 49 | 0 | 11 | 4 | 18 | 11 | 5 |
| Treatment 1 E3 | 50 | 49 | 1 | 0 | 7 | 17 | 22 | 2 |
| Treatment 1 E4 | 50 | 50 | 0 | 1 | 11 | 13 | 21 | 4 |
| Treatment 1 E9 | 50 | 48 | 2 | 2 | 7 | 17 | 17 | 3 |
| Treatment 2 E1 | 50 | 50 | 0 | 4 | 5 | 13 | 23 | 5 |

The stages refer to growth stages of the life cycle, where the higher the number the more advanced the growth stage.

Some prior binders can negatively affect seed germination. Table 8 shows germination results for two treatments with various alkyd resins. The treatments comprising the binders of the present invention had no detrimental impact on germination.

The data showed that all treatments had comparable germination results meaning the alkyd resin emulsion did not impact the seed germination rate. The results also showed good binder performance of the alkyd resin.

It is to be understood that the invention is not to be limited to the details of the above embodiments, which are described by way of example only. Many variations are possible.

1. A film coating composition comprising:
i) a binder selected from an alkyd resin formed from C2 to C16 diacids, C6 to C30 fatty acids, and C3 to C8 polyols; and
ii) optionally, at least one selected from an agrochemical active, nutrient, or biostimulant.

2. The film coating composition according to claim 1, wherein the polyol is selected from glycerol, diglycerol, triglycerol, tetraglycerol, trimethylolpropane, trimethylolpropane, isosorbide, or pentaerythritol.

3. The film coating composition according to claim 2, wherein the polyol is selected from glycerol, diglycerol, trimethylolpropane, or pentaerythritol.

4. The film coating composition according to claim 1, wherein the polyol is a sugar alcohol selected from glucose, fructose, sorbitol, sorbitan, xylitol, threitol, ribitol, fucitol, mannitol, sucrose, galactitol, iditol, inositol, or volemitol.

5. The film coating composition according to claim 1, wherein the diacid is a linear C4 to C10 diacid.

6. The film coating composition according to claim 5, wherein the diacid is selected from succinic acid, glutaric acid, adipic acid, pimelic acid, suberic acid, azelaic acid, sebacic acid, and undecanedioic acid.

7. The film coating composition according to claim 1, wherein the fatty acids are C8 to C30 fatty acids.

8. The film coating composition according to claim 7, wherein the fatty acids are selected from isostearic, stearic, isostearic, caprylic, lauric, and mixtures thereof.

9. The film coating composition according to claim 1, wherein the alkyd resin is formed from a combination of: glycerol-azelaic acid-rapeseed oil, glycerol-isostearic acid-adipic acid, glycerol-succinic acid-soybean oil, pentaerythritol-azelaic acid-soybean oil, trimethylolpropane-adipic acid-soybean oil, glycerol-adipic acid-isostearic acid, glycerol-azelaic acid-stearic/isostearic acid blend, diglycerol-azelaic acid-stearic/isostearic acid blend, diglycerol-sebacic acid-soybean oil, pentaerythritol-sebacic acid-soybean oil, glycerol-adipic acid-lauric acid, pentaerythritol-succinic anhydride-soybean oil, glycerol-adipic acid-adipic acid-stearic acid, pentaerythritol-adipic acid-caprylic acid, and glycerol-azelaic acid-soybean oil and stearic acid blend.

10. The film coating composition according to claim 1, wherein the molecular weight of the alkyd resin is from 3,000 to 220,000 Da.

11. The film coating composition according to claim 1, wherein the amount of polyols present in the alkyd resin is in the range from 5 to 45 wt. % as a percentage of the total copolymer weight.

12. The film coating composition according to claim 1, wherein the amount of diacid present in the alkyd resin is in the range from 2 to 60 wt. % as a percentage of the total copolymer weight.

13. The film coating composition according to claim 1, wherein the amount of fatty acids present in the alkyd resin is in the range from 20 to 85 wt. % as a percentage of the total copolymer weight.

14. The film coating composition according to claim 1, wherein the molar ratio of the fatty acid to polyol to diacid is in the range 1:0.35-0.60:0.60-0.95.

15. The film coating composition according to claim 1, wherein the alkyd resin is in an emulsified form or an emulsification system

16. A method of forming the film coating composition according to claim 1, which comprises combining
i) a binder selected from an alkyd resin formed from C2 to C16 diacids, C6 to C30 fatty acids, and C3 to C8 polyols; and
ii) optionally, at least one selected from an agrochemical active, nutrient, or biostimulant dispersed in a water medium.

17. A method of coating seeds which comprises applying a seed coating composition which comprises a film coating composition in accordance with claim 1, to the seeds.

18. Seeds with a seed coating, the seed coating composition comprising a film coating composition in accordance with claim 1.

19. (canceled)

20. Use of an alkyd resin formed from C2 to C16 diacids, C6 to C30 fatty acids, and C3 to C8 polyols, as a binder for a film coating composition for seeds.

21. An emulsified formulation comprising a binder selected from an alkyd resin formed from C2 to C16 diacids, C6 to C30 fatty acids, and C3 to C8 polyols, suitable for aqueous seed application.
